(19) United States
(12) Patent Application Publication
(10) Pub. No.: US 2026/0112903 A1
(43) Pub. Date: Apr. 23, 2026

(54) CHARGING AND DISCHARGING SYSTEM AND CHARGING AND DISCHARGING METHOD

(71) Applicant: VIA Technologies, Inc., New Taipei City (TW)

(72) Inventors: Liang-Chen Yang, New Taipei City (TW); Yi-Wei Li, New Taipei City (TW)

(73) Assignee: VIA Technologies, Inc., New Taipei City (TW)

(21) Appl. No.: 18/984,965

(22) Filed: Dec. 17, 2024

(30) Foreign Application Priority Data
Oct. 21, 2024 (TW) 113139962

(51) Int. Cl. H02J 7/00; H02J 7/34

(52) U.S. Cl. CPC H02J 7/485; H02J 7/345; H02J 7/40; H02J 7/80; H02J 7/855; H02J 7/96; H02J 2207/50

(57) ABSTRACT

A charging and discharging system and a charging and discharging method are provided. The charging and discharging system includes a battery module detection circuit, a charging and discharging controller, and a microcontroller. The battery module detection circuit receives a detection signal of a battery module and generates a battery type determination signal and a deep discharge detection signal based on the detection signal. The microcontroller controls the charge and discharge controller to perform a charging operation or a discharging operation on the battery module. When the microcontroller determines that the battery module is a first battery type based on the battery type determination signal, the microcontroller controls the charge and discharge controller to perform a deep discharge protection function based on the deep discharge detection signal. When the microcontroller determines that the battery module is a second battery type based on the battery type determination signal, the microcontroller controls the charge and discharge controller to stop the deep discharge protection function.

### CROSS-REFERENCE TO RELATED APPLICATION

This application claims the priority benefit of Taiwan application Ser. No. 113139962, filed on Oct. 21, 2024. The entirety of the above-mentioned patent application is hereby incorporated by reference herein and made a part of this specification.

### BACKGROUND

### Technical Field

The disclosure relates to a system, and particularly relates to a charging and discharging system and a charging and discharging method.

### Description of Related Art

A general charging and discharging device cannot be applied to energy storage devices of different battery types. Moreover, even if the charging and discharging device is to be applied to energy storage devices of different battery types, the existing approach requires designing different charging and discharging systems in order to provide corresponding battery charging and discharging and battery protection functions respectively. Furthermore, it is not possible to arbitrarily swap between energy storage devices of different battery types.

### SUMMARY

The disclosure provides a charging and discharging system and a charging and discharging method, which are suitable for performing charging and discharging operations of battery modules of different battery types.

The charging and discharging system of the disclosure includes a battery module detection circuit, a charging and discharging controller, and a microcontroller. The battery module detection circuit is coupled to the battery module, is configured to receive a detection signal of the battery module, and generates a battery type determination signal and a deep discharge detection signal based on the detection signal. The charging and discharging controller is coupled to the battery module detection circuit and the battery module. The microcontroller is coupled to the battery module detection circuit and the charging and discharging controller, and is configured to control the charging and discharging controller to perform a charging operation or a discharging operation on the battery module. When the microcontroller determines that the battery module is a first battery type based on the battery type determination signal, the microcontroller controls the charging and discharging controller based on the deep discharge detection signal to perform a deep discharge protection function. When the microcontroller determines that the battery module is a second battery type based on the battery type determination signal, the microcontroller controls the charging and discharging controller to stop the deep discharge protection function.

The charging and discharging method of the disclosure includes steps as follows: receiving, through a battery module detection circuit, a detection signal of a battery module, and generating a battery type determination signal and a deep discharge detection signal based on the detection signal; controlling, through a microcontroller, a charging and discharging controller to perform a charging operation or a discharging operation on the battery module; controlling, through the microcontroller, the charging and discharging controller based on the deep discharge detection signal to perform a deep discharge protection function when the microcontroller determines that the battery module is a first battery type based on the battery type determination signal; and controlling, through the microcontroller, the charging and discharging controller to stop the deep discharge protection function when the microcontroller determines that the battery module is a second battery type based on the battery type determination signal.

Based on the above, the charging and discharging system and the charging and discharging method of the disclosure can automatically determine the battery type of the battery module, and have the function of supporting the charging and discharging operations of battery modules of different battery types. The charging and discharging system and the charging and discharging method of the disclosure can further determine whether to provide the deep discharge protection function according to battery modules of different battery types.

In order to make the foregoing features and advantages of the disclosure more comprehensible, embodiments are given below and described in detail with reference to the accompanying drawings.

### BRIEF DESCRIPTION OF THE DRAWINGS

FIG. 1 is a schematic diagram of a charging and discharging system according to an embodiment of the disclosure.

FIG. 2 is a flow chart of a charging and discharging method according to an embodiment of the disclosure.

FIG. 3 is a schematic diagram of the charging and discharging system according to an embodiment of the disclosure.

FIG. 4 is a circuit diagram of a battery module detection circuit according to an embodiment of the disclosure.

FIG. 5 is a circuit diagram of a temperature detection circuit according to an embodiment of the disclosure.

FIG. 6 is a flow chart of a charging protection function according to an embodiment of the disclosure.

FIG. 7 is a flow chart of a discharge protection function according to an embodiment of the disclosure.

### DESCRIPTION OF THE EMBODIMENTS

In order to make the content of the disclosure more comprehensible, the following embodiments are given as examples according to which the disclosure may be implemented. In addition, wherever possible, elements/components/steps with the same reference signs in the drawings and embodiments represent the same or similar parts.

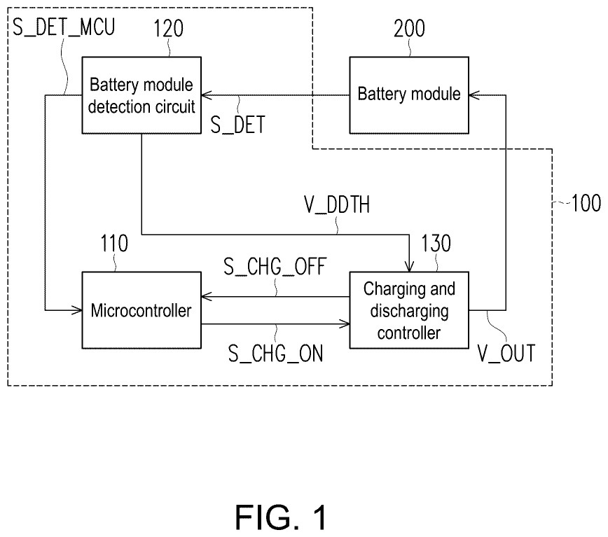

FIG. 1 is a schematic diagram of a charging and discharging system according to an embodiment of the disclosure. Referring to FIG. 1, a charging and discharging system 100 includes a microcontroller (MCU) 110, a battery module detection circuit 120, and a charging and discharging controller 130. The microcontroller 110 is coupled to the battery module detection circuit 120 and the charging and discharging controller 130. The battery module detection circuit 120 is further coupled to the battery module 200. The charging and discharging controller 130 is further coupled to the battery module 200. The battery module 200 may include one or more battery packs. In the embodiment, the charging and discharging system 100 may support charging and discharging battery modules of a first battery type and a second battery type. In an embodiment, the first battery type may be a lithium-ion battery, and the second battery type may be a lithium-ion super capacitor, but the disclosure is not limited thereto. In other embodiments, the charging and discharging system 100 may also support other battery types or support two or more battery types.

In the embodiment, the charging and discharging system 100 may be a power control unit, and the connection interface of the charging and discharging system 100 includes a plurality of pins. At least one or more of the plurality of pins of the charging and discharging system 100 may be coupled to the battery positive electrode of the battery module 200, and at least one or more of the plurality of pins of the charging and discharging system 100 may be coupled to the battery negative electrode of the battery module 200. One of the plurality of pins of the charging and discharging system 100 may further obtain a detection signal S_DET of the battery module 200. In an embodiment, the charging and discharging system 100 may further obtain a temperature detection voltage of the battery module 200 through another one of the plurality of pins.

In the embodiment, the battery module detection circuit 120 may detect the battery type of the battery module 200, and the microcontroller 110 may perform charging and discharging operations on the battery module 200 according to the battery type of the battery module 200. In the embodiment, the charging and discharging system 100 may further provide different charging and discharging functions according to the battery type of the battery module 200. In an embodiment, the charging and discharging system 100 may detect at least one of a battery voltage and a battery temperature of the battery module 200, to provide the corresponding charge protection function, discharge protection function, and/or deep discharge protection function according to at least one of the battery voltage and the battery temperature.

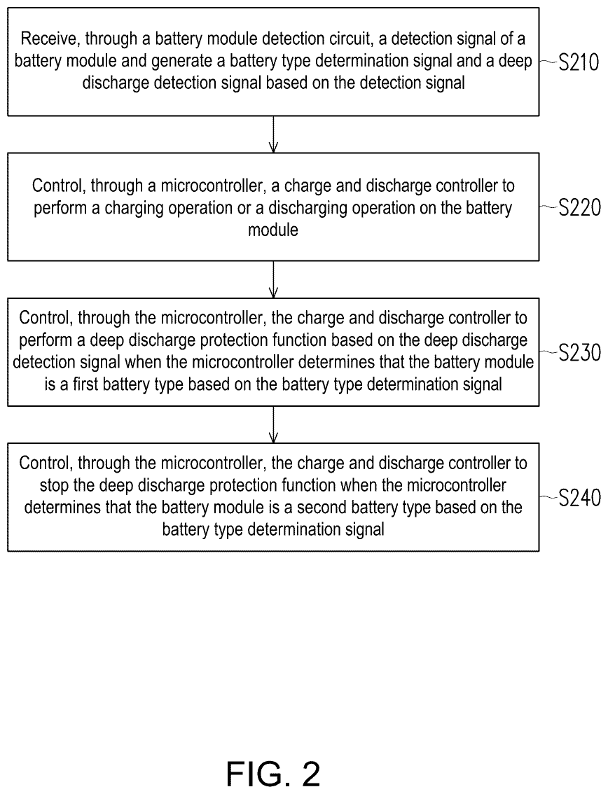

FIG. 2 is a flow chart of a charging and discharging method according to an embodiment of the disclosure. Referring to FIG. 1 and FIG. 2, the charging and discharging system 100 in FIG. 1 may perform Steps S210 to S240 as follows. In Step S210, the battery module detection circuit 120 may receive the detection signal S_DET of the battery module 200, and generate a battery type determination signal S_DET_MCU and a deep discharge detection signal V_DDTH based on the detection signal S_DET. The battery module detection circuit 120 may output the battery type determination signal S_DET_MCU to the microcontroller 110, and may output the deep discharge detection signal V_DDTH to the charging and discharging controller 130. In Step S220, the microcontroller 110 may control the charging and discharging controller 130 to perform a charging operation or a discharging operation on the battery module 200. In the charging operation and the discharging operation, the microcontroller 110 may provide the charge protection function and the discharge protection function respectively.

In the embodiment, the microcontroller 110 may output a control signal S_CHG_ON to the charging and discharging controller 130 to control the charging and discharging controller 130 to perform the charging operation on the battery module 200. The charging and discharging controller 130 may provide an output voltage V_OUT to the battery module 200. When the battery module 200 completes charging, the charging and discharging controller 130 may further output a charging completion signal S_CHG_OFF to the microcontroller 110 so that the microcontroller 110 may stop the charging operation or perform related overcurrent protection operations.

Moreover, in an embodiment, the charging and discharging system 100 may also operate the battery module 200 to provide power to an external electronic device, such as a data storage device, a mobile device, an industrial control device, a vehicle-mounted device, or other consumer electronic products, and the disclosure is not limited thereto. The microcontroller 110 may also control the charging and discharging controller 130 to perform the discharging operation on the battery module 200 to provide power to the external electronic device. In another embodiment, the microcontroller 110 may also control the battery module 200 and be coupled to a discharge circuit, in which the discharge circuit may include a DC-to-DC converter and may be used to provide power to the external electronic device.

In Step S230, when the microcontroller 110 determines that the battery module 200 is the first battery type based on the battery type determination signal S_DET_MCU, the microcontroller 110 may control the charging and discharging controller 130 to perform the deep discharge protection function based on the deep discharge detection signal V_DDTH. In Step S240, when the microcontroller 110 determines that the battery module 200 is the second battery type based on the battery type determination signal S_DET_MCU, the microcontroller 110 may control the charging and discharging controller 130 to stop the deep discharge protection function.

In an embodiment, the first battery type may be a lithium-ion battery, and the second battery type may be a lithium-ion super capacitor. When the microcontroller 110 determines that the battery module 200 is the lithium-ion battery based on the battery type determination signal S_DET_MCU, the charging and discharging controller 130 may provide the deep discharge protection function based on the deep discharge detection signal V_DDTH. It should be noted that the deep discharge protection function refers to performing an additional precharging operation on the battery module 200 belonging to the first battery type in order to prevent the battery module 200 belonging to the first battery type from over-discharging, thereby avoiding damage to the battery.

Specifically, when the charging and discharging controller 130 determines that a voltage value of the deep discharge detection signal V_DDTH is lower than a preset voltage threshold (the preset voltage threshold may be lower than 6.6 volts), it is indicated that the battery module 200 enters a battery deep discharge state, and the charging and discharging controller 130 may cause the battery module 200 to enter a precharge state to protect the battery module 200. However, when the microcontroller 110 determines that the battery module 200 is the lithium-ion super capacitor based on the battery type determination signal S_DET_MCU, since the lithium-ion super capacitor does not require deep discharge protection measures, the microcontroller 110 may stop (or disable or deactivate) the deep discharge protection function.

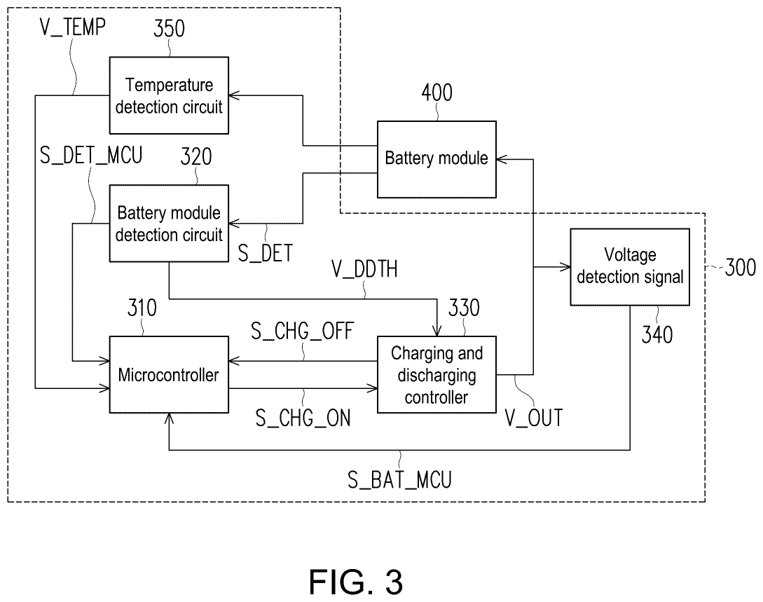

FIG. 3 is a schematic diagram of the charging and discharging system according to an embodiment of the disclosure. Referring to FIG. 3, a charging and discharging system 300 includes a microcontroller 310, a battery module detection circuit 320, a charging and discharging controller 330, a voltage detection circuit 340, and a temperature detection circuit 350. The microcontroller 310 is coupled to the battery module detection circuit 320, the charging and discharging controller 330, the voltage detection circuit 340, and the temperature detection circuit 350. The battery module detection circuit 320 is further coupled to the charging and discharging controller 330 and the battery module 400. The voltage detection circuit 340 is further coupled to the charging and discharging controller 330 and the battery module 400. The battery module detection circuit 320 is further coupled to the charging and discharging controller 330.

In the embodiment, the battery module detection circuit 320 may receive the detection signal S_DET of the battery module 400, and may generate the battery type determination signal S_DET_MCU and the deep discharge detection signal V_DDTH based on the detection signal S_DET. The battery module detection circuit 320 may output the battery type determination signal S_DET_MCU to the microcontroller 310, and output the deep discharge detection signal V_DDTH to the charging and discharging controller 330. In the embodiment, the voltage detection circuit 340 may detect the output voltage V_OUT of the battery module 400 to generate a voltage detection signal S_BAT_MCU to the microcontroller 310. In an embodiment, the voltage detection signal S_BAT_MCU may be generated by using the resistor voltage division result of the output voltage V_OUT. In the embodiment, the microcontroller 310 may control the charging and discharging controller 330 to perform the charging operation or the discharging operation on the battery module 400 based on the voltage detection signal S_BAT_MCU. In this regard, the microcontroller 110 may output the control signal S_CHG_ON to the charging and discharging controller 330 based on the voltage detection signal S_BAT_MCU, so that the charging and discharging controller 330 determines to perform the charging operation on the battery module 400 based on the control signal S_CHG_ON. In addition, during the charging operation, the microcontroller 310 may provide overvoltage protection based on the voltage detection signal S_BAT_MCU, and the charging and discharging controller 330 may determine whether the battery module 400 has completed charging, and output the charging completion signal S_CHG_OFF to the microcontroller 310. In addition, in the discharging operation, the microcontroller 310 may further determine whether to stop the discharging operation based on the voltage detection signal S_BAT_MCU, and may further determine whether the battery module 400 belongs to the first battery type based on the battery type determination signal S_DET_MCU, so as to further provide the deep discharge protection function based on the deep discharge detection signal V_DDTH.

When the microcontroller 310 determines that the battery module 400 is the first battery type based on the battery type determination signal S_DET_MCU, and performs the discharging operation on the battery module 400, the microcontroller 310 may control the charging and discharging controller 330 to provide the deep discharge protection function based on the deep discharge detection signal V_DDTH. When the microcontroller 310 determines that the battery module 400 is the second battery type based on the battery type determination signal S_DET_MCU, and performs the discharging operation on the battery module 400, the microcontroller 310 may control the charging and discharging controller 330 to stop the deep discharge protection function. The first battery type may be a lithium-ion battery, and the second battery type may be a lithium-ion super capacitor.

In the embodiment, the temperature detection circuit 350 may detect the battery temperature of the battery module 400 and output a temperature detection voltage V_TEMP to the microcontroller 310. The microcontroller 310 may determine to read a first lookup table corresponding to the first battery type or a second lookup table corresponding to the second battery type based on the battery type determination signal S_DET_MCU. In this regard, since different battery types have different voltage-temperature relationships, the microcontroller 310 may search the first lookup table or the second lookup table based on the temperature detection voltage V_TEMP to obtain the corresponding battery temperature. Moreover, the microcontroller 310 may determine the battery voltage of the battery module 400 based on the voltage detection signal S_BAT_MCU. The microcontroller 310 may control the charging and discharging controller 330 to perform the charging operation or the discharging operation on the battery module 400 according to the battery voltage and the battery temperature.

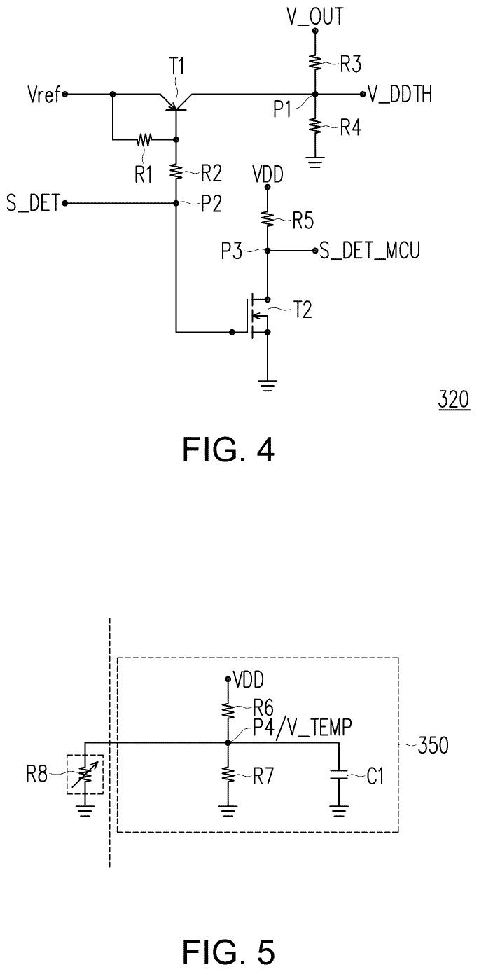

FIG. 4 is a circuit diagram of the battery module detection circuit according to an embodiment of the disclosure. Referring to FIG. 4, in an embodiment, the battery module detection circuit 320 in FIG. 3 may have a circuit architecture as shown in FIG. 4, but the disclosure is not limited thereto. The battery module detection circuit 320 may include transistors T1, T2 and resistors R1 to R5. The first terminal of the transistor T1 is coupled to a reference voltage Vref. The second terminal of the transistor T1 is coupled to a circuit node P1. The first circuit node P1 may be used to provide the deep discharge detection signal V_DDTH. The resistor R1 is coupled between the control terminal and the first terminal of the transistor T1. The resistor R2 is coupled between the control terminal of the transistor T1 and a circuit node P2. The second circuit node P2 may receive the detection signal S_DET. The resistor R3 is coupled between the output voltage V_OUT of the battery module 400 and the circuit node P1. The resistor R4 is coupled between the circuit node P1 and a ground terminal. The first terminal of the transistor T2 is coupled to a circuit node P3. The second terminal of the transistor T2 is coupled to the ground terminal. The control terminal of the transistor T2 is coupled to the circuit node P2. The circuit node P3 is used to provide the battery type determination signal S_DET_MCU. The resistor R5 is coupled between an operating voltage VDD (for example, 3.3 volts) and the circuit node P3.

The transistor T1 may be a PNP type bipolar junction transistor (BJT), and the transistor T2 is an N-type metal oxide semiconductor field effect transistor (MOSFET). The first terminal of the transistor T1 may be the emitter. The second terminal of the transistor T1 may be the collector. The control terminal of the transistor T1 may be the base. The first terminal of the transistor T2 may be the drain. The second terminal of the transistor T2 may be the source. The control terminal of the transistor T1 may be the gate.

The connector of the battery module 400 corresponding to the charging and discharging system 300 may have a specific pin to provide the detection signal S_DET. If the battery module 400 is a lithium-ion battery, then the specific pin may be in a floating state. If the battery module 400 is a lithium-ion super capacitor, then the specific pin may be in a ground state. Therefore, when the battery module 400 is the lithium-ion battery, the transistor T1 is off and the transistor T2 is on. The deep discharge detection signal V_DDTH may be the voltage division result of the output voltage V_OUT via the resistor R3 and the resistor R4, and the charge and discharge controller 330 as shown in FIG. 3 may provide the deep discharge protection function based on the deep discharge detection signal V_DDTH. Furthermore, the battery type determination signal S_DET_MCU may have a low voltage level (such as a ground level), so that the microcontroller 310 can effectively determine that the battery module 400 is a lithium-ion battery.

In contrast, when the battery module 400 is the lithium-ion super capacitor, the transistor T1 is on and the transistor T2 is off. The deep discharge detection signal V_DDTH may be fixed to the reference voltage Vref, so that the charge and discharge controller 330 as shown in FIG. 3 may stop the deep discharge protection function. Furthermore, the battery type determination signal S_DET_MCU may have a high voltage level (such as the operating voltage VDD level), so that the microcontroller 310 can effectively determine that the battery module 400 is a lithium-ion super capacitor.

FIG. 5 is a circuit diagram of the temperature detection circuit according to an embodiment of the disclosure. Referring to FIG. 5, in an embodiment, the temperature detection circuit 350 in FIG. 3 may have a circuit architecture as shown in FIG. 5, but the disclosure is not limited thereto. The temperature detection circuit 350 includes resistors R6 to R7 and a capacitor C1. The resistor R6 is coupled between the operating voltage VDD and a circuit node P4. The circuit node P4 is used to provide the temperature detection voltage V_TEMP. The resistor R7 is coupled between the circuit node P4 and the ground terminal. The capacitor C1 is coupled between the circuit node P4 and the ground terminal. It should be noted that the circuit node P4 is further coupled to a negative temperature coefficient resistor R8 through the connector of the battery module 400 corresponding to the charging and discharging system 300. The negative temperature coefficient resistor R8 may be disposed in the battery module 400 as shown in FIG. 3, in which the resistance value changes with the temperature of the battery module 400, and the temperature detection voltage V_TEMP may reflect the temperature of the battery module 400.

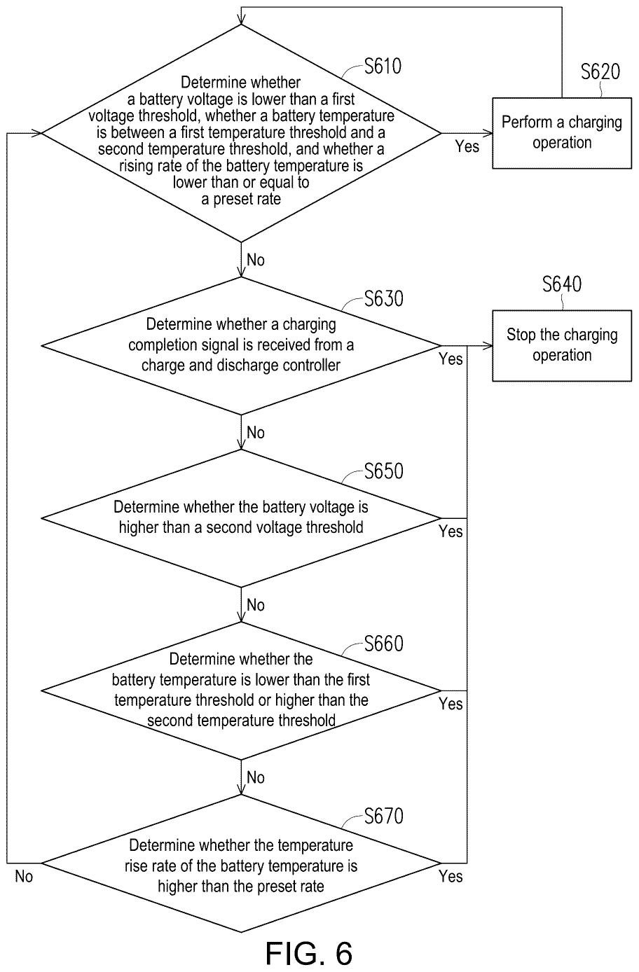

FIG. 6 is a flow chart of the charging protection function according to an embodiment of the disclosure. Referring to FIG. 3 and FIG. 6, during the charging process, the charging and discharging system 300 may perform Steps S610 to S670 as follows to implement the charging protection function. In Step S610, the microcontroller 310 may determine whether the battery voltage is lower than the first voltage threshold (for example, determine through the voltage detection signal S_BAT_MCU), whether the battery temperature is between the first temperature threshold and the second temperature threshold, and whether a rising rate of the battery temperature is lower than or equal to a preset rate (for example, determine through the temperature detection voltage V_TEMP, the battery type determination signal S_DET_MCU, and the first or second lookup table). If yes, then it means that the battery voltage, the battery temperature, and the rising rate of the battery temperature all meet the three conditions, then the microcontroller 310 may perform Step S620 to perform the charging operation. The microcontroller 310 may, for example, switch the control signal S_CHG_ON from a low voltage level to a high voltage level to notify the charging and discharging controller 330 to perform the charging operation. If not, then the microcontroller 310 may perform subsequent Steps S630 and S650 to S670 for further determination. In an embodiment, the first voltage threshold may be, for example, 7.9 volts. The first temperature threshold is lower than the second temperature threshold. The first temperature threshold may be, for example, −30 degrees. The second temperature threshold may be, for example, 65 degrees. The preset rate may be, for example, a temperature change (increase) of 5 degrees per second.

In Step S630, the microcontroller 310 may determine whether the charging completion signal S_CHG_OFF is received from the charging and discharging controller 330. Receiving the charging completion signal S_CHG_OFF may, for example, mean that the charging completion signal S_CHG_OFF is switched from the low voltage level to the high voltage level. If yes, then the microcontroller 310 may perform Step S640 to stop the charging operation. The microcontroller 310 may, for example, switch the control signal S_CHG_ON from the high voltage level to the low voltage level to notify the charging and discharging controller 330 to stop the charging operation. If not, then the microcontroller 310 may perform Step S650 for the next determination.

In Step S650, the microcontroller 310 may determine whether the battery voltage is higher than the second voltage threshold. If yes, then the microcontroller 310 may perform Step S640 to stop the charging operation. In an embodiment, the second voltage threshold may be, for example, 8.2 volts. If not, then the microcontroller 310 may perform Step S660 for the next determination.

In Step S660, the microcontroller 310 may determine whether the battery temperature is lower than the first temperature threshold or higher than the second temperature threshold. If yes, then the microcontroller 310 may perform Step S640 to stop the charging operation. If not, then the microcontroller 310 may perform Step S670 for the next determination.

In Step S670, the microcontroller 310 may determine whether the temperature rise rate of the battery temperature is higher than the preset rate. If yes, then the microcontroller 310 may perform Step S640 to stop the charging operation. If not, then the microcontroller 310 may perform Step S610 again after a preset time period to perform the foregoing determinations cyclically. In other words, when any condition of Steps S630 and S650 to S670 is met, the microcontroller 310 stops the charging operation.

Therefore, the charging and discharging system 300 can provide good charging protection function. In addition, it should be noted that the operation order of Steps S630 and S650 to S670 may be changed arbitrarily, and is not limited to the content shown in FIG. 6.

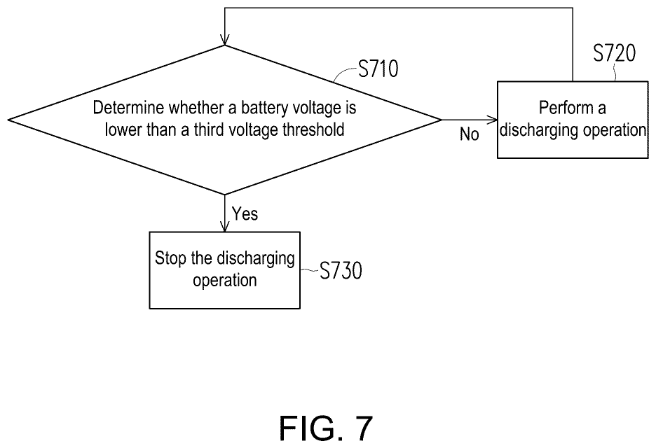

FIG. 7 is a flow chart of the discharge protection function according to an embodiment of the disclosure. Referring to FIG. 3 and FIG. 7, during the discharge process, the charging and discharging system 300 may perform Steps S710 to S730 as follows to implement the discharge protection function. In Step S710, the microcontroller 310 may determine whether the battery voltage is lower than a third voltage threshold. If not, then the microcontroller 310 may perform Step S720 to perform the discharging operation. Moreover, the microcontroller 310 may then perform Step S710 again after a preset time period to perform the discharge determination cyclically. If yes, then the microcontroller 310 may perform Step S730 to stop the discharging operation. In an embodiment, the third voltage threshold may be, for example, 6.6 volts. Therefore, the charging and discharging system 300 can provide good discharge protection function.

Moreover, as explained in the foregoing embodiments, after stopping the discharging operation, if the microcontroller 310 determines that the battery module 400 belongs to the first battery type based on the battery type determination signal S_DET_MCU, then the microcontroller 310 may further control the charging and discharging controller 330 to provide the deep discharge protection function based on the deep discharge detection signal V_DDTH.

In summary, the charging and discharging system and the charging and discharging method of the disclosure can support the charge and discharge protection functions of battery modules of multiple battery types, and further provide the deep discharge protection functions for battery modules of specific battery types.

Although the disclosure has been disclosed above through embodiments, the embodiments are not intended to limit the disclosure. Persons with ordinary knowledge in the relevant technical field may make some changes and modifications without departing from the spirit and scope of the disclosure. Therefore, the protection scope of the disclosure shall be determined by the appended claims.

What is claimed is:

1. A charging and discharging system, comprising:
a battery module detection circuit coupled to a battery module, configured to receive a detection signal of the battery module, and generating a battery type determination signal and a deep discharge detection signal based on the detection signal,
a charging and discharging controller coupled to the battery module detection circuit and the battery module; and
a microcontroller coupled to the battery module detection circuit and the charging and discharging controller, and configured to control the charging and discharging controller to perform a charging operation or a discharging operation on the battery module,
wherein the microcontroller controls the charging and discharging controller to perform a deep discharge protection function based on the deep discharge detection signal in response to the microcontroller determining that the battery module is a first battery type based on the battery type determination signal,
wherein the microcontroller controls the charging and discharging controller to stop the deep discharge protection function in response to the microcontroller determining that the battery module is a second battery type based on the battery type determination signal.

2. The charging and discharging system as claimed in claim 1, wherein the first battery type is a lithium-ion battery, and the second battery type is a lithium-ion super capacitor.

3. The charging and discharging system as claimed in claim 1, wherein the battery module detection circuit comprises:
a first transistor, wherein a first terminal of the first transistor is coupled to a reference voltage, and a second terminal of the first transistor is coupled to a first circuit node;
a first resistor coupled between the control terminal and the first terminal of the first transistor;
a second resistance coupled between a control terminal of the first transistor and a second circuit node, wherein the second circuit node receives the detection signal;
a second transistor, wherein a first terminal of the second transistor is coupled to a third circuit node, a second terminal of the second transistor is coupled to a ground terminal, a control terminal of the second transistor is coupled to the second circuit node, and the third circuit node is configured to provide the battery type determination signal; and
a fifth resistor coupled between an operating voltage and the third circuit node.

4. The charging and discharging system as claimed in claim 3, wherein the battery module detection circuit further comprises:
a third resistor coupled between an output voltage of the battery module and the first circuit node, wherein the first circuit node is configured to provide the deep discharge detection signal;
and a fourth resistor coupled between the first circuit node and the ground terminal.

5. The charging and discharging system as claimed in claim 1, further comprising:
a voltage detection circuit coupled to the battery module and the microcontroller, and configured to detect an output voltage of the battery module to generate a voltage detection signal,
wherein the microcontroller controls the charging and discharging controller to perform the charging operation or the discharging operation on the battery module based on the voltage detection signal.

6. The charging and discharging system as claimed in claim 5, wherein the microcontroller outputs a control signal to the charging and discharging controller based on the voltage detection signal, so that the charging and discharging controller determines to perform the charging operation on the battery module based on the control signal.

7. The charging and discharging system as claimed in claim 5, further comprising:
a temperature detection circuit coupled to the battery module and the microcontroller, and configured to output a temperature detection voltage to the microcontroller,
wherein the microcontroller determines to read a first lookup table corresponding to the first battery type or a second lookup table corresponding to the second battery type based on the battery type determination signal, and the microcontroller searches the first lookup table or the second lookup table based on the temperature detection voltage to obtain a battery temperature,
wherein the microcontroller determines a battery voltage of the battery module based on the voltage detection signal, and the microcontroller controls the charging and discharging controller to perform the charging operation or the discharging operation on the battery module according to the battery voltage and the battery temperature.

8. The charging and discharging system as claimed in claim 7, wherein in response to the microcontroller determining that the battery voltage is lower than a first voltage threshold, that the battery temperature is between a first temperature threshold and a second temperature threshold, and that a rising rate of the battery temperature is lower than or equal to a preset rate, the microcontroller controls the charging and discharging controller to perform the charging operation on the battery module, and the first temperature threshold is lower than the second temperature threshold.

9. The charging and discharging system as claimed in claim 7, wherein in response to the microcontroller receiving a charging completion signal from the charging and discharging controller, the microcontroller controls the charging and discharging controller to stop performing the charging operation on the battery module.

10. The charging and discharging system as claimed in claim 7, wherein in response to the microcontroller determining that the battery voltage is higher than a second voltage threshold, the microcontroller controls the charging and discharging controller to stop performing the charging operation on the battery module.

11. The charging and discharging system as claimed in claim 7, wherein in response to the microcontroller determining that the battery temperature is lower than a first temperature threshold or higher than a second temperature threshold, the microcontroller controls the charging and discharging controller to stop performing the charging operation on the battery module, and the first temperature threshold is lower than the second temperature threshold.

12. The charging and discharging system as claimed in claim 7, wherein in response to the microcontroller determining that a temperature rise rate of the battery temperature is higher than a preset rate, the microcontroller controls the charging and discharging controller to stop performing the charging operation on the battery module.

13. The charging and discharging system as claimed in claim 7, wherein in response to the microcontroller performing the discharging operation on the battery module, the microcontroller determines whether the battery voltage is lower than a third voltage threshold to stop performing the discharging operation.

14. The charging and discharging system as claimed in claim 7, wherein the temperature detection circuit comprises:
a sixth resistor coupled between an operating voltage and a fourth circuit node, wherein the fourth circuit node is configured to provide the temperature detection voltage;
a seventh resistor coupled between the fourth circuit node and a ground terminal; and
a capacitor coupled between the fourth circuit node and the ground terminal.

15. The charging and discharging system as claimed in claim 14, wherein the fourth circuit node is further coupled to a negative temperature coefficient resistor of the battery module.

16. A charging and discharging method, comprising:
receiving, through a battery module detection circuit, a detection signal of a battery module, and generating a battery type determination signal and a deep discharge detection signal based on the detection signal;
controlling, through a microcontroller, a charging and discharging controller to perform a charging operation or a discharging operation on the battery module;
controlling, through the microcontroller, the charging and discharging controller based on the deep discharge detection signal to perform a deep discharge protection function in response to the microcontroller determining that the battery module is a first battery type based on the battery type determination signal; and
controlling, through the microcontroller, the charging and discharging controller to stop the deep discharge protection function in response to the microcontroller determining that the battery module is a second battery type based on the battery type determination signal.

17. The charging and discharging method as claimed in claim 16, further comprising:
detecting an output voltage of the battery module through a voltage detection circuit to generate a voltage detection signal; and
controlling, through the microcontroller, the charging and discharging controller to perform the charging operation or the discharging operation on the battery module based on the voltage detection signal.

18. The charging and discharging method as claimed in claim 17, further comprising:
outputting, through a temperature detection circuit, a temperature detection voltage to the microcontroller;
determining, through the microcontroller to read a first lookup table corresponding to the first battery type or a second lookup table corresponding to the second battery type based on the battery type determination signal;
searching, through the microcontroller, the first lookup table or the second lookup table based on the temperature detection voltage to obtain a battery temperature;
determining, through the microcontroller, a battery voltage of the battery module based on the voltage detection signal; and
controlling, through the microcontroller, the charging and discharging controller to perform the charging operation or the discharging operation on the battery module according to the battery voltage and the battery temperature.

19. The charging and discharging method as claimed in claim 18, wherein controlling the charging and discharging controller to perform the charging operation on the battery module according to the battery voltage and the battery temperature comprises:
controlling, through the microcontroller, the charging and discharging controller to perform the charging operation on the battery module in response to the microcontroller determining that the battery voltage is lower than a first voltage threshold, that the battery temperature is between a first temperature threshold and a second temperature threshold, and that a rising rate of the battery temperature is lower than or equal to a preset rate, wherein the first temperature threshold is lower than the second temperature threshold.

20. The charging and discharging method as claimed in claim 18, wherein controlling the charging and discharging controller to perform the charging operation on the battery module according to the battery voltage and the battery temperature comprises:
controlling, through the microcontroller, the charging and discharging controller to stop performing the charging operation on the battery module in response to the microcontroller receiving a charging completion signal from the charging and discharging controller, the microcontroller determining that the battery voltage is higher than a second voltage threshold, the microcontroller determining that the battery temperature is lower than a first temperature threshold or higher than a second temperature threshold, or the microcontroller determining that a temperature rise rate of the battery temperature is higher than a preset rate.
